(19) United States
(12) Patent Application Publication
(10) Pub. No.: US 2020/0073751 A1
(43) Pub. Date: Mar. 5, 2020

(54) STORAGE APPARATUS AND RECORDING MEDIUM

(71) Applicant: FUJITSU LIMITED, Kawasaki-shi (JP)

(72) Inventor: Akira Sampei, Kawasaki (JP)

(73) Assignee: FUJITSU LIMITED, Kawasaki-shi (JP)

(21) Appl. No.: 16/551,810

(22) Filed: Aug. 27, 2019

(30) Foreign Application Priority Data
Sep. 5, 2018 (JP) 2018-165580

(51) Int. Cl. G06F 11/07; G06F 13/16; G06F 11/30; G06F 11/34

(52) U.S. Cl. CPC G06F 11/0793; G06F 11/0727; G06F 11/0757; G06F 11/3485; G06F 13/1668; G06F 11/3027; G06F 11/079

(57) ABSTRACT

A storage apparatus includes a memory; a relay device configured to relay access to the memory; and a processor coupled to the relay device and configured to when anomaly is detected by monitoring for the relay device, perform diagnostic testing with respect to the access to the memory via the relay device, and when it is detected that the access is failed, change a threshold time in accordance with whether a redundant path connecting to the memory exists, the threshold time indicating a period from a time when it is detected that the access is failed to a time when disconnection of the relay device from communication with the processor is performed.

### CROSS-REFERENCE TO RELATED APPLICATION

This application is based upon and claims the benefit of priority of the prior Japanese Patent Application No. 2018-165580, filed on Sep. 5, 2018, the entire contents of which are incorporated herein by reference.

### FIELD

The embodiments discussed herein are related to a storage apparatus and a recording medium.

### BACKGROUND

A storage system includes a recording device, such as a hard disk drive (HDD) or a solid state drive (SSD), a controller that controls the recording device, and a relay module that connects the controller and the recording device to each other and stores and manages a multitude of data to be used in information processing.

The storage system involves a redundant configuration for the purpose of securing reliability. For example, to couple the controller and the recording device to each other via multiple routes, multiple paths are formed between the controller and the recording device via relay modules.

With regard to such a storage system involving a redundant configuration, a technology for detecting the location of anomaly at the time of the occurrence of a fault to continue the operation is developed. As related art, for example, Japanese Unexamined Utility Model Application Publication No. 4-47748, Japanese Laid-open Patent Publication No. 3-144722, Japanese Laid-open Patent Publication No. 2002-149500, and Japanese Laid-open Patent Publication No. 2006-318246 are disclosed.

When anomaly is detected at a relay module in a storage system, the relay module is disconnected from communication with the controller.

In the case in which there is a redundant path connecting to a recording device associated with the relay module at which the anomaly occurs, when the anomaly is detected at the relay module connected to one path, it is possible to achieve communication with the recording device via another relay module connected to the other path. Hence, in the case in which there is a redundant path, when anomaly is detected at a particular relay module, the particular relay module may be immediately disconnected from communication with the controller.

In contrast, in the case in which there is no redundant path connecting to a recording device associated with the relay module at which the anomaly is detected, if the particular relay module is disconnected from communication with the controller when anomaly is detected, the operation of the system immediately stops.

When anomaly is detected at a relay module, it is possible that the anomaly does not affect directly the system operation. Hence, in the case in which there is no redundant path, when anomaly is detected at a particular relay module, it is preferable that the particular relay module be not immediately disconnected from communication with the controller and the operation of the system be continued for a given period.

However, in the known storage system, regardless of whether there is a redundant path, whenever anomaly is detected at a relay module, the relay module is disconnected from communication with the controller and this consequently causes decrease of operability and reliability. In view of the conditions described above, it is desirable to determine whether to continue the operation at the location of anomaly in accordance with the configuration of the apparatus.

### SUMMARY

According to an aspect of the embodiments, a storage apparatus includes a memory; a relay device configured to relay access to the memory; and a processor coupled to the relay device and configured to when anomaly is detected by monitoring for the relay device, perform diagnostic testing with respect to the access to the memory via the relay device, and when it is detected that the access is failed, change a threshold time in accordance with whether a redundant path connecting to the memory exists, the threshold time indicating a period from a time when it is detected that the access is failed to a time when disconnection of the relay device from communication with the processor is performed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a configuration of a storage apparatus;

FIG. 2 illustrates an example of a configuration of a storage system;

FIG. 3 illustrates an example of a hardware configuration of a CM;

FIG. 4 illustrates an example of functional blocks of the CM;

FIG. 5 illustrates an example of an average-response-time management table;

FIG. 6 illustrates an example of a redundant-path information management table;

FIG. 7 illustrates an example of the number of redundant data paths;

FIG. 8 illustrates another example of the number of redundant data paths;

FIG. 9 is a flowchart illustrating overall operation of a controller;

FIG. 10 is a flowchart illustrating average-response-time acquisition operation;

FIG. 11 is a flowchart illustrating operation of DISK Read command issuing processing;

FIG. 12 is a flowchart illustrating operation of IOM operation continuation determination processing; and

FIG. 13 is another flowchart illustrating the operation of IOM operation continuation determination processing.

### DESCRIPTION OF EMBODIMENTS

Hereinafter, embodiments will be described with reference to the drawings.

### First Embodiment

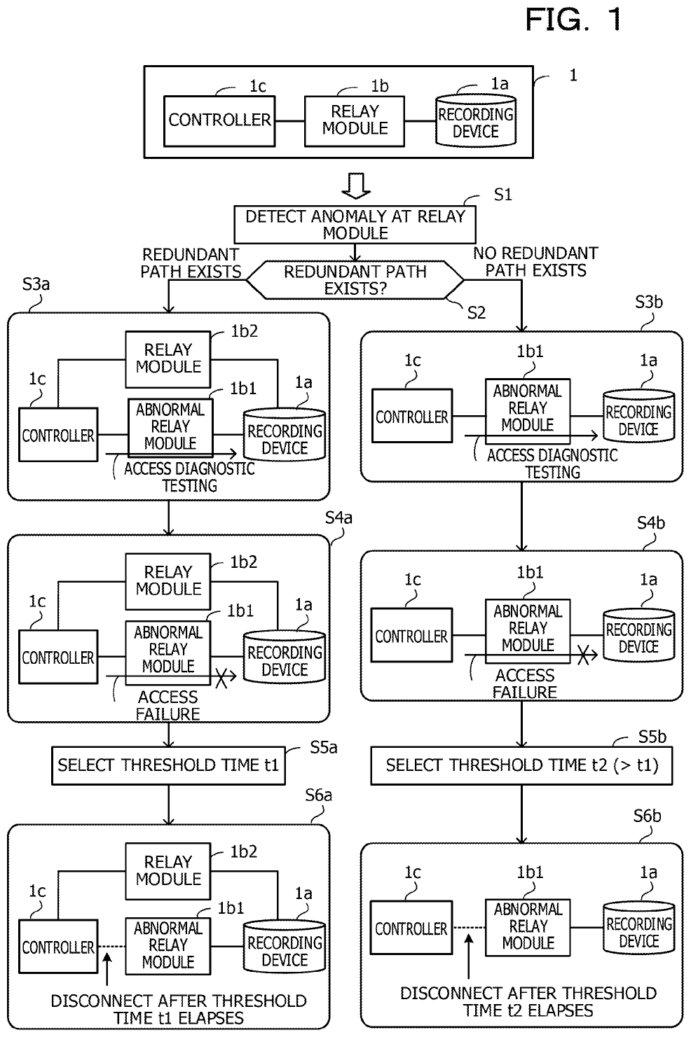

A first embodiment is described with reference to FIG. 1. FIG. 1 illustrates an example of a configuration of a storage apparatus. A storage apparatus 1 includes a recording device 1a, a relay module 1b, and a controller 1c.

The relay module 1b relays access from the controller 1c to the recording device 1a. When anomaly is detected while anomaly monitoring is performed with respect to the relay module 1b, the controller 1c performs diagnostic testing about access to the recording device 1a via the relay module 1b. When it is detected that the access to the recording device 1a is failed, the controller 1c changes a threshold time in accordance with whether a redundant path connecting to the recording device 1a exists. The threshold time denotes a time period from the time when an access failure is detected to the time when disconnection is performed.

An operation is described by using an example illustrated in FIG. 1.

[Step S1] It is assumed that the controller 1c performs anomaly monitoring with respect to a relay module and detects anomaly occurring at the relay module (hereinafter, the relay module at which anomaly is detected is also referred to as the abnormal relay module).

[Step S2] The controller 1c determines whether there is a redundant path connecting to the recording device 1a associated with the abnormal relay module. When a redundant path exists, the process proceeds to step S3a. Conversely, when no redundant path exists, the process proceeds to step S3b.

[Step S3a] The controller 1c performs diagnostic testing about access to the recording device 1a via the abnormal relay module 1b1. Between the controller 1c and the recording device 1a, a redundant path passing via a relay module 1b2 exists.

[Step S4a] The controller 1c detects an access failure as the result of performing diagnostic testing about the access to the recording device 1a via the abnormal relay module 1b1.

[Step S5a] The controller 1c changes the threshold time used for determining the time when the corresponding abnormal relay module is disconnected from communication and starts counting the threshold time.

The threshold time is a period from the time when it is detected that access is failed to the time when disconnection is performed in the case in which it is determined, in diagnostic testing about access to the recording device 1a via the abnormal relay module, that access is failed.

The length of the threshold time varies depending on whether a redundant path exists and the length of the threshold time is selected from multiple prepared options. For example, when a threshold time t1<a threshold time t2, in the case in which a redundant path exists, the threshold time t1 is selected; and conversely, in the case in which no redundant path exists, the threshold time t2 is selected. Since a redundant path exists in the case of step S5a, the controller 1c selects the threshold time t1 and starts counting the threshold time t1.

[Step S6a] After the threshold time t1 elapses since access failure has been detected, the controller 1c disconnects communication with the abnormal relay module 1b1.

[Step S3b] The controller 1c performs diagnostic testing about access to the recording device 1a via the abnormal relay module 1b1. Between the controller 1c and the recording device 1a, only the abnormal relay module 1b1 is coupled and no redundant path exists.

[Step S4b] The controller 1c detects access failure as the result of performing diagnostic testing about the access to the recording device 1a via the abnormal relay module 1b1.

[Step S5b] The controller 1c changes the threshold time used for determining the time when the corresponding abnormal relay module is disconnected from communication and starts counting the threshold time. Since no redundant path exists in the case of step S5b, the controller 1c selects the threshold time t2 (t2>t1) and starts counting the threshold time t2.

[Step S6b] After the threshold time t2 elapses since access failure has been detected, the controller 1c disconnects communication with the abnormal relay module 1b1.

As described above, by determining the threshold time t2, which is used when no redundant path to the recording device 1a exists, to be longer than the threshold time t1, which is used when a redundant path exists, the controller 1c disconnects communication with the abnormal relay module in the case of access failure when no redundant path exists later than disconnecting communication with the abnormal relay module in the case of access failure when a redundant path exists.

In this manner, when a redundant path exists, disconnection of the location of anomaly is performed shortly after the detection of access failure and the system operation is continued by using the redundant path. When no redundant path exists, disconnection of the location of anomaly is performed at a later time and the system operation is continued for a certain period without immediately stopping the system operation.

Consequently, the storage apparatus 1 enables determination of continuity of operation regarding the location of anomaly in accordance with the configuration of the apparatus, and as a result, operability and reliability may be improved.

### Second Embodiment

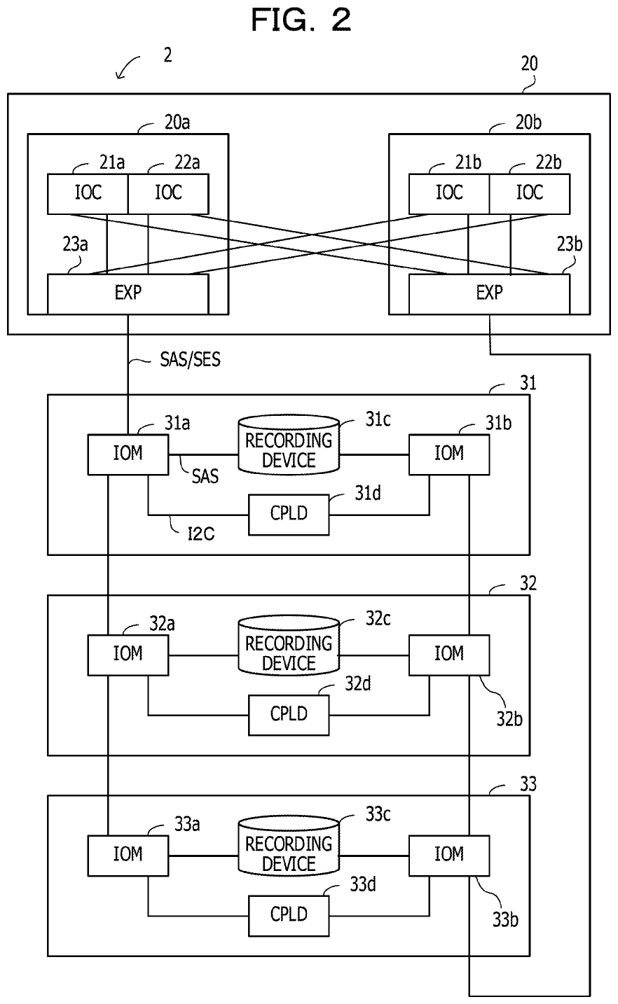

Next, a second embodiment is described. Firstly, a configuration of a system is described. FIG. 2 illustrates an example of a configuration of a storage system. The storage system 2 involves a redundant array of inexpensive disks (RAID) in which multiple recording devices are combined. The storage system 2 includes a controller enclosure (CE) 20 and disc enclosures (DEs) 31, 32, and 33.

The CE 20 includes controller modules (CMs) 20a and 20b. The CMs 20a and 20b control input/output (I/O) operation with respect to the DEs 31, 32, and 33 in accordance with instructions provided by a host (not illustrated). The CMs 20a and 20b correspond to the controller 1c of the storage apparatus 1.

The CM 20a includes input output controllers (IOCs) 21a and 22a, and an expander (EXP) 23a. The CM 20b includes IOCs 21b and 22b, and an EXP 23b.

The DE 31 includes input output modules (IOM) 31a and 31b, a recording device (a disk) 31c, and a complex programmable logic device (CPLD) 31d. The DE 32 includes IOMs 32a and 32b, a recording device 32c, and a CPLD 32d. The DE 33 includes IOM 33a and 33b, a recording device 33c, and a CPLD 33d.

The IOCs 21a and 22a control input/output interface with regard to the CM 20a, and the DE 31, 32, and 33 while the IOCs 21b and 22b control input/output interface with regard to the CM 20b, and the DE 31, 32, and 33. The EXP 23a and 23b are expander devices that respectively connect the CMs 20a and 20b to the DE 31, 32, and 33.

The IOMs are relay modules. The IOMs 31a and 31b respectively relay between the CMs 20a and 20b, and the recording device 31c. The IOMs 32a and 32b respectively relay between the CMs 20a and 20b, and the recording device 32c, while the IOM 33a and 33b respectively relay between the CMs 20a and 20b, and the recording device 33c. The CPLD 31d, 32d, and 33d control management of the IOMs and the recording devices and also control, for example, I/O expansion, interface bridging, and power supply management.

Concerning the connection relationships among the components, the IOCs 21a and 22a, and the EXP 23a are coupled to each other in the CM 20a while the IOCs 21b and 22b, and the EXP 23b are coupled to each other in the CM 20b. The IOCs 21a and 22a in the CM 20a are coupled to the EXP 23b in the CM 20b while the IOCs 21b and 22b in the CM 20b are coupled to the EXP 23a in the CM 20a.

In the DE 31, the recording device 31c is coupled to the IOMs 31a and 31b while the CPLD 31d is also coupled to the IOMs 31a and 31b. In the DE 32, the recording device 32c is coupled to the IOMs 32a and 32b while the CPLD 32d is also coupled to the IOMs 32a and 32b. In the DE 33, the recording device 33c is coupled to the IOMs 33a and 33b while the CPLD 33d is also coupled to the IOMs 33a and 33b.

As an interface coupling the IOM and the CPLD, for example, an inter integrated circuit (I2C)/a general purpose input/output (GPIO) is used (hereinafter referred to as the I2C interface).

The EXP and the IOMs are coupled to each other in a serial manner. In the example in FIG. 2, the EXP 23a in the CM 20a is coupled to the IOM 31a in the DE 31; the IOM 31a is coupled to the IOM 32a in the DE 32; and the IOM 32a is coupled to the IOM 33a in the DE 33.

The EXP 23b in the CM 20b is coupled to the IOM 33b in the DE 33; the IOM 33b is coupled to the IOM 32b in the DE 32; and the IOM 32b is coupled to the IOM 31b in the DE 31. The EXP 23b may be coupled to the IOM 31b.

As an interface coupling the EXP and the IOM, for example, a serial attached small computer system interface (SAS)/a small computer system interface (SCSI) enclosure service (SES) is used. As an interface coupling the TOM and the recording device, for example, an SAS interface (a first interface) is used.

In the storage system 2, anomaly monitoring for the DE is carried out by monitoring processing performed by the CM. In the storage system 2, in addition to an SAS interface for general I/O accesses between the CM and the DE, the DE includes an I2C interface (a second interface) that is used for anomaly monitoring for the IOM in the DE.

When anomaly is detected at the IOM, communication between the CM and the IOM is disconnected within a given time period, so that the system operation (for example, I/O access from a host) is continued by using normal hardware devices.

The CM monitors, by using the I2C interface, the IOM with respect to monitoring attributes such as the condition of power supply of the IOM and the condition of mounted components of the IOM (the condition of whether a component is mounted or unmounted at the time of maintenance check). An abnormal mode (a failure mode) of the IOM includes two kinds of anomalies, specifically, anomalies that affect the continuation of system operation and anomalies that do not affect the continuation of system operation.

One example of anomalies that affect the continuation of system operation is, for example, the case in which the power of IOM is down. The anomaly in which the power of IOM is down immediately affects system operation and thus is a sever anomaly in regard to operation.

In contrast, one example of anomalies that do not affect the continuation of system operation is, for example, the case in which a mount signal (a signal output from the IOM when a component is mounted in a normal state) is not obtained from the IOM targeted for monitoring. The anomaly in which a mount signal is not obtained affects the operation of maintenance replacement of the IOM but does not immediately affect system operation, and thus, this case is a minor anomaly in regard to operation.

Since it is difficult to distinguish between these two kinds of anomalies by performing anomaly monitoring by using the I2C interface, in known technologies, the CM and the IOM are disconnected from communication when anomaly not affecting the continuation of system operation occurs. As a result, operability and reliability of system operation decreases.

As described above, in the known technologies, regardless of whether a redundant path exists, whenever anomaly is detected at the IOM, the CM and the IOM are disconnected from communication and this consequently causes decrease of operability and reliability.

In consideration of these aspects, the present disclosure is made in which the time period for which the operation of an abnormal IOM is continued is changed depending on the redundant configuration of a device, and by determining whether anomaly affects the continuation of system operation, it is possible to determine whether to continue the operation at the location of the anomaly in accordance with the configuration of the device.

<Hardware Configuration>

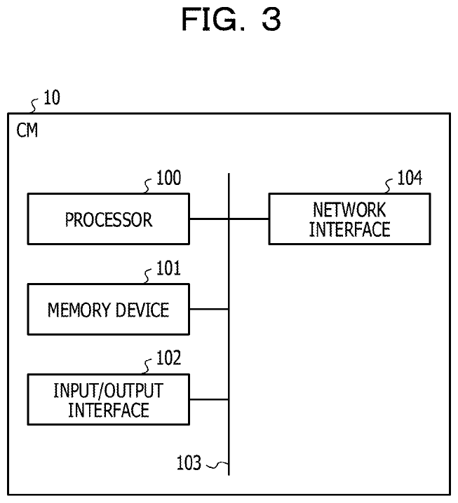

Hereinafter, the second embodiment is described in detail. FIG. 3 illustrates an example of a hardware configuration of a CM. A CM 10 is entirely controlled by a processor 100. Specifically, the processor 100 functions as a controller of the CM 10 and also implements the function of an IOC.

A memory device 101 and a plurality of pieces of peripheral equipment are connected to the processor 100 through a bus 103. The processor 100 may be a multiprocessor. The processor 100 is, for example, a central processing unit (CPU), a micro processing unit (MPU), a digital signal processor (DSP), an application-specific integrated circuit (ASIC), or a programmable logic device (PLD). Alternatively, the processor 100 may be any combination of two or more of the CPU, the MPU, the DSP, the ASIC, and the PLD.

The memory device 101 is used as a primary recording device of the CM 10. Any one or any combination of an operating system (OS) program and application programs, which are executed by the processor 100, is temporarily stored in the memory device 101. Various types of data used for processing performed by the processor 100 are stored in the memory device 101.

The memory device 101 is also used as an auxiliary recording device of the CM 10, and an OS program, application programs, and various types of data are stored therein. The memory device 101 may include, as an auxiliary recording device, a semiconductor recording device, such as a flash memory or an SSD, and/or a magnetic recording medium, such as an HDD.

The peripheral equipment connected to the bus 103 includes an input/output interface 102 and a network interface 104. A monitor (for example, a light-emitting diode (LED) or a liquid-crystal display (LCD)) is connected to the input/output interface 102 and functions as a display device for displaying the state of the CM 10 in accordance with an instruction from the processor 100.

The input/output interface 102 may be coupled with an information input device such as a keyboard or a mouse, and configured to transmit, to the processor 100, a signal transferred from the information input device.

The input/output interface 102 also functions as a communication interface for coupling with a peripheral instrument. For example, an optical drive device that reads data recorded on an optical disk by using laser light or the like may be connected to the input/output interface 102. The optical disk includes a Blu-ray Disc (registered trademark), a compact disc read only memory (CD-ROM), a compact disc-recordable (CD-R), and a compact disc-rewritable (CD-RW).

A memory device and a memory reader/writer may be connected to the input/output interface 102. The memory device is a recording medium having a function of communicating with the input/output interface 102. The memory reader/writer is a device for writing data to a memory card or reading data from a memory card. The memory card is a card-type recording medium.

The network interface 104 has the function of the EXP and performs interface control with respect to the DE. The network interface 104 has a function of interface control with respect to an external network and may be implemented as, for example, a network interface card (NIC), a wireless LAN card, or the like. Data received by the network interface 104 is output to the memory device 101 and the processor 100.

With the hardware configuration described above, processing functions of the CM 10 may be implemented. For example, the CM 10 performs control according to the present disclosure through the processor 100 executing a predetermined computer program.

In the CM 10, for example, the processing functions in the present disclosure may be realized by executing a program recorded in a computer-readable recording medium. A program in which content of processing to be executed by the CM 10 may be recorded in various recording media.

For example, the program to be executed by the CM 10 may be stored in an auxiliary recording device. The processor 100 loads into the primary recording device at least part of the program stored in the auxiliary recording device and executes the program.

The program to be run by the CM 10 may be recorded in a portable recording medium such as an optical disk, a memory device, or a memory card. The program stored in/on a portable recording medium is executable after being installed to, for example, an auxiliary recording device, under the control of the processor 100. The processor 100 may also execute the program by directly reading the program from a portable recording medium.

<Functional Block>

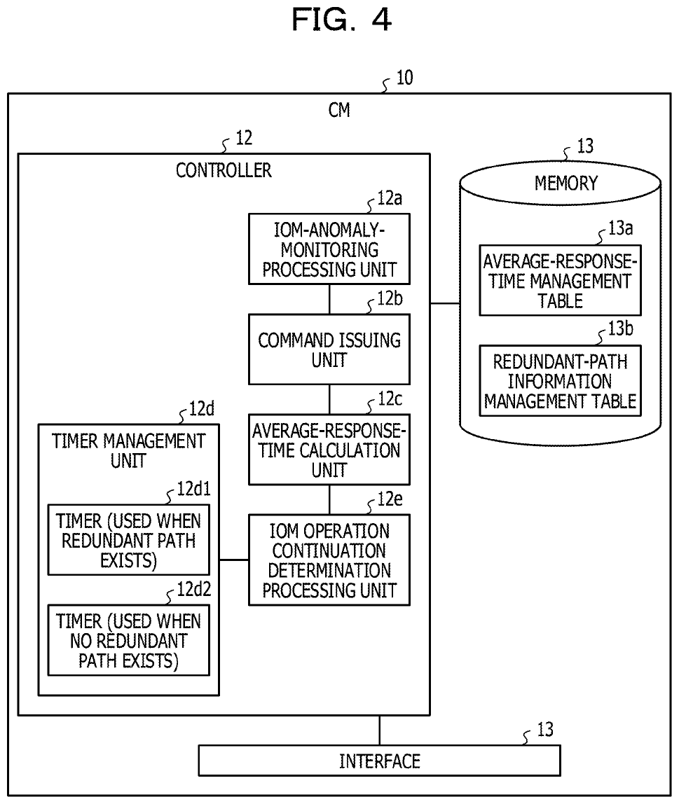

FIG. 4 illustrates an example of functional blocks of the CM. The CM 10 includes an interface 11, a controller 12, and a memory 13. The interface 11 performs interface control with regard to the DE and other devices.

The controller 12 includes an TOM-anomaly-monitoring processing unit 12a, a command issuing unit 12b, an average-response-time calculation unit 12c, a timer management unit 12d, and an IOM operation continuation determination processing unit 12e.

The TOM-anomaly-monitoring processing unit 12a performs anomaly monitoring with respect to the IOM in the DE by using the I2C interface. When the TOM-anomaly-monitoring processing unit 12a detects anomaly at an TOM, the command issuing unit 12b issues, via the IOM (the abnormal IOM) at which anomaly is detected, a command for performing access diagnostic testing for a recording device associated with the abnormal IOM. As the command, for example, the Disk Read command for reading data from a recording device is utilized.

When access diagnostic testing is performed, the average-response-time calculation unit 12c calculates an average response time to be taken to provide a response with respect to the command issued by the command issuing unit 12b.

The timer management unit 12d has two timer functions consisting of a timer 12d1 (used when a redundant path exists) and a timer 12d2 (used when no redundant path exists) The timer management unit 12d sets a time for the timers (sets a threshold time) and controls, for example, driving of the timers.

The timer 12d1 is used when the abnormal IOM is disconnected from communication with the CM 10 in the case in which there is a redundant path connecting to a recording device associated with the abnormal IOM. The timer 12d2 is used when the abnormal IOM is disconnected from communication with the CM 10 in the case in which there is no redundant path connecting to a recording device associated with the abnormal IOM.

The threshold time t2 counted by the timer 12d2 is determined to be longer than the threshold time t1 counted by the timer 12d1.

When access is failed during access diagnostic testing, the TOM operation continuation determination processing unit 12e disconnects the abnormal IOM from communication by using different threshold times depending on whether a redundant path exists.

In this case, when there is a redundant path connecting to a recording device associated with the abnormal IOM, the IOM operation continuation determination processing unit 12e starts the timer 12d1; and when the timer 12d1 indicates time-out, the IOM operation continuation determination processing unit 12e disconnects the abnormal IOM from communication.

In this case, when there is no redundant path connecting to a recording device associated with the abnormal IOM, the IOM operation continuation determination processing unit 12e starts the timer 12d2; and when the timer 12d2 indicates time-out, the IOM operation continuation determination processing unit 12e disconnects the abnormal IOM from communication.

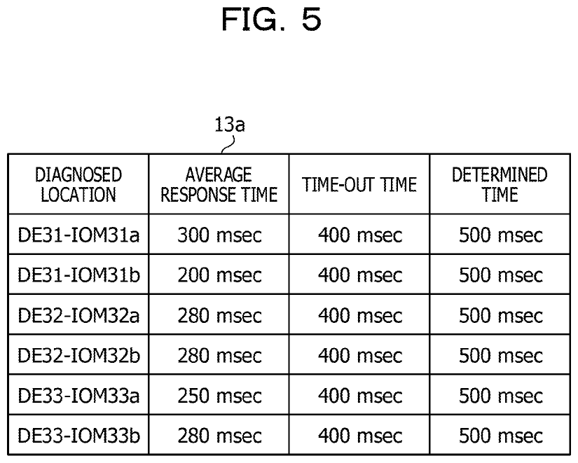

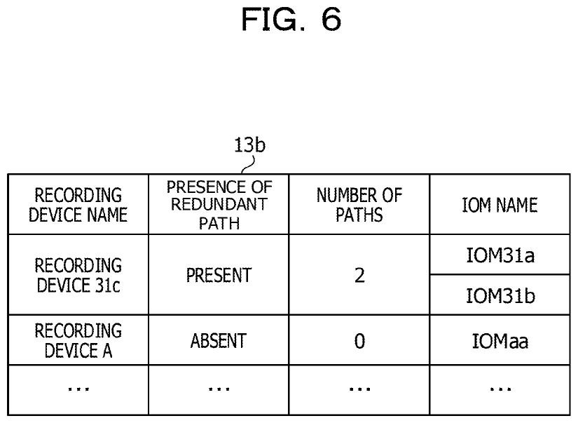

The memory 13 stores data structured as an average-response-time management table 13a and data structured as the redundant-path information management table 13b, which will be described in detail later with reference to FIGS. 5 and 6.

The interface 11 is implemented as the network interface 104 in FIG. 3; the controller 12 is implemented as the processor 100 in FIG. 3; and the memory 13 is implemented as the memory device 101 in FIG. 3.

<Average-Response-Time Management Table and Redundant-Path Information Management Table>

FIG. 5 illustrates an example of an average-response-time management table. The average-response-time management table 13a contains fields as follows: diagnosed location (suspect location), average response time, time-out time, and determined time.

In the field of diagnosed location, for example, information about the IOM in the DE is registered. The average response time denotes an average response time calculated by the average-response-time calculation unit 12c, that is, an average time taken to provide a command response that is output by a recording device via an IOM indicated by a diagnosed location.

The controller 12 regularly issues a read command for a recording device, accordingly calculates an average response time with respect to the read command, and registers the average response time in the average-response-time management table 13a. The controller 12 calculates the average-response-time, for example, such that (the total time taken for reading a disk)/(the number of times a disk has been read).

Although the DISK Read command is used as a command used when access diagnostic testing is performed, the DISK Write command, the Write Verify command, or the Test Unit Ready command may be used for access diagnostic testing.

However, the DISK Read command and the Write Verify command takes time longer than the DISK Read command and it is difficult to check a connection by using the Test Unit Ready command. Hence, the controller 12 desirably uses the DISK Read command, with which the processing is faster than the DISK Write and it is possible to check a connection.

The time-out time is used for detecting an abnormal IOM. When no response is provided by the time when a time-out time elapses, it is determined that the IOM indicated by a diagnosed location is abnormal. The determined time is a time taken until disconnection of a suspect location is performed (for example, several tens msec order) in the processing in which anomaly monitoring with respect to an IOM is performed by using the I2C interface. The determined time is a time taken until the disconnection of an IOM determined to be abnormal from the CM is performed.

As the threshold time t1 counted by the timer 12d1, for example, an average response time registered in the average-response-time management table 13a is used. As the threshold time t2 counted by the timer 12d2, for example, a determined time registered in the average-response-time management table 13a or a time equal to or shorter than a determined time is used.

FIG. 6 illustrates an example of a redundant-path information management table. The redundant-path information management table 13b contains fields as follows: recording device name, presence of redundant path, number of paths, and IOM name. The recording device name is identification information indicating a particular recording device. In the field of presence of redundant path, information indicating whether there is any redundant path between the CM and a particular recording device is registered. In the field of the number of paths, the number of redundant paths is registered. The IOM name is identification information indicating a particular IOM connected to each redundant path.

In the example in FIG. 6, concerning the recording device 31c, there are redundant paths between the CM and the recording device 31c and the number of redundant paths is two. According to the identification information about IOMs associated with the redundant paths, one of the two redundant paths accesses the recording device 31c via the IOM 31a while the other of the two redundant paths accesses the recording device 31c via the IOM 31b.

Concerning a recording device A, there is no redundant path between the CM and the recording device A and the number of redundant paths is zero. It is seen from the table that one path accesses the recording device A via an IOM aa.

In the average-response-time management table 13a and the redundant-path information management table 13b, the controller 12 registers various fields of information at the time of the initial operation. The controller 12 regularly monitors change in configuration and redundancy during system operation, and when any change is detected at the time of, for example, the occurrence of failure or recovery, the controller 12 registers a predetermined type of information corresponding to the change.

<Number of Redundant Data Paths>

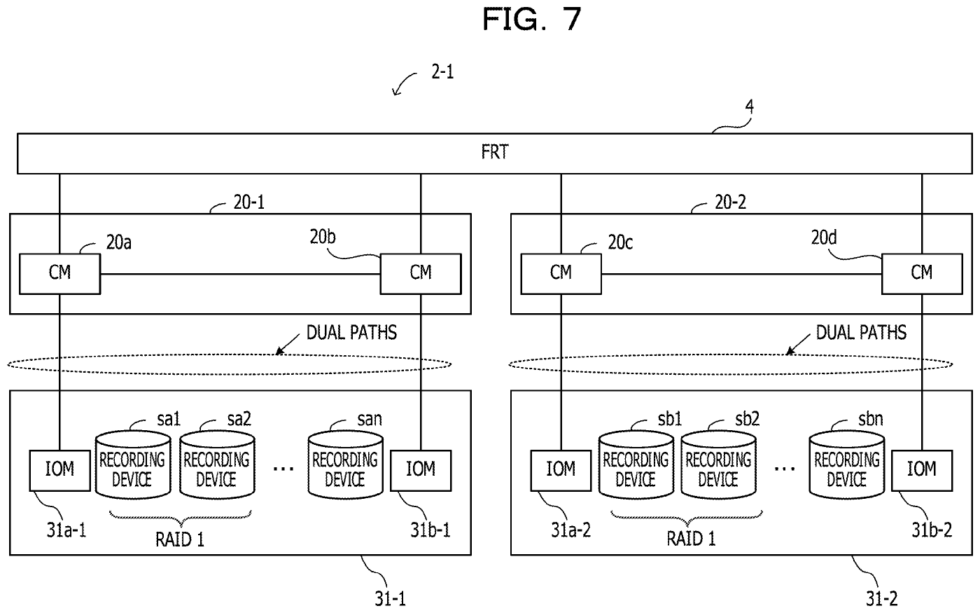

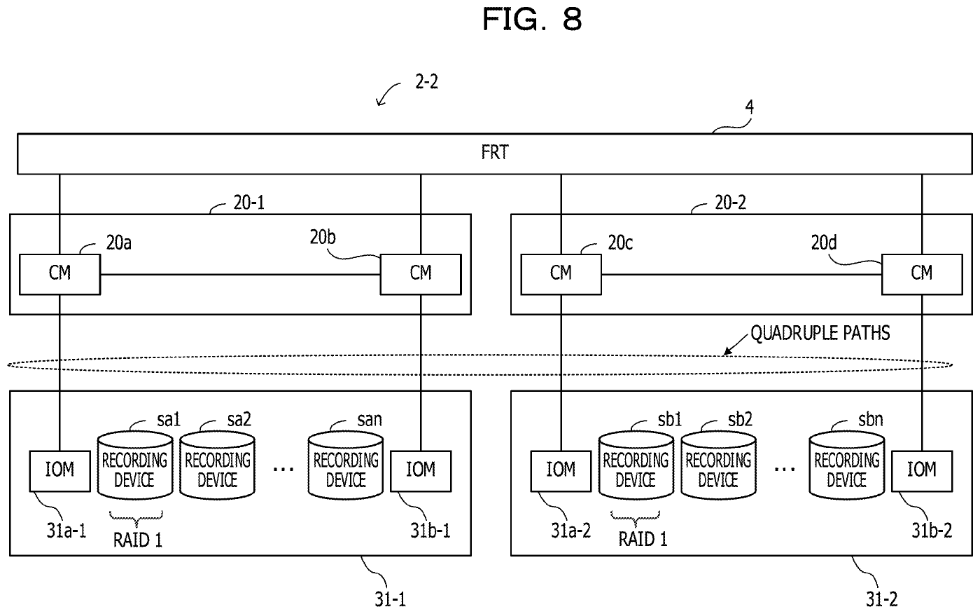

FIGS. 7 and 8 illustrate examples of the number of redundant data paths. When a storage system has a redundant configuration, data paths are formed in, for example, a dual or quadruple manner, which denotes the number of redundant paths, depending on the disk deployment method.

Storage systems 2-1 and 2-2 both involve CEs 20-1 and 20-2, DE 31-1 and 31-2, and a front end router (FRT) 4. The CE 20-1 also includes the CMs 20a and 20b while the CE 20-2 includes CMs 20c and 20d (the EXP, the CPLD, and the like are not illustrated in the drawings).

The DE 31-1 includes IOMs 31a-1 and 31b-1, and recording devices sa1, sa2, . . . , and san, while the DE 31-2 includes IOMs 31a-2 and 31b-2, and recording devices sb1, sb2, . . . , sbn.

The CM 20a is coupled to the FRT 4, the CM 20b, and the IOM 31a-1, while the CM 20b is coupled to the FRT 4, the CM 20a, and the IOM 31b-1. The CM 20c is coupled to the FRT 4, the CM 20d, and the IOM 31a-2, while the CM 20d is coupled to the FRT 4, the CM 20c, and the IOM 31b-2.

Here, it is assumed that the recording devices in the DE includes recording devices configured as RAID 1. The storage system 2-1 illustrated in FIG. 7 involves the two recording devices sa1 and sat that are configured as RAID 1 in the DE 31-1 and the two recording devices sb1 and sb2 that are configured as RAID 1 in the DE 31-2. When recording devices configured as RAID 1 are stored in the same DE as described above, two IOMs access the recording devices configured as RAID 1, and thus, data paths are formed in a dual manner.

The storage system 2-2 illustrated in FIG. 8 involves the one recording device sa1 configured as RAID 1 in the DE 31-1 and the one recording device sb1 configured as RAID 1 in the DE 31-2.

When recording devices configured as RAID 1 are stored separately in DEs belonging to different cascades as described above, four IOMs access the recording devices configured as RAID 1, and thus, data paths are formed in a quadruple manner. In the both system configurations, accessing data in RAID 1 is possible when a single path is available.

When multiple RAID configurations exist in DEs, the number of redundant data paths is determined to be the smallest number of redundant data paths among the RAID configurations. As described above, when two recording devices configured as RAID 1 are stored separately in DEs belonging to different cascades, data paths are formed in a quadruple manner.

In contrast, when two recording devices configured as RAID 1 are stored in the same DE, data paths are formed in a dual manner. In the case describe above in which the one RAID 1 configuration has four paths while the other RAID 1 has two paths, considering that the number of redundant data paths is determined to be the smallest number among them, it is assumed that data paths are formed in a dual manner, and thus, the number of redundant paths is two.

<Flowchart>

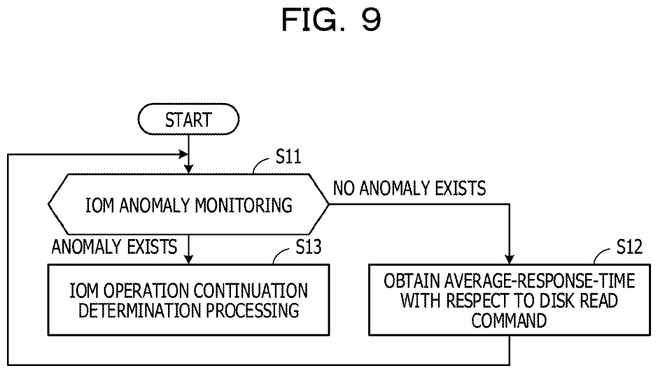

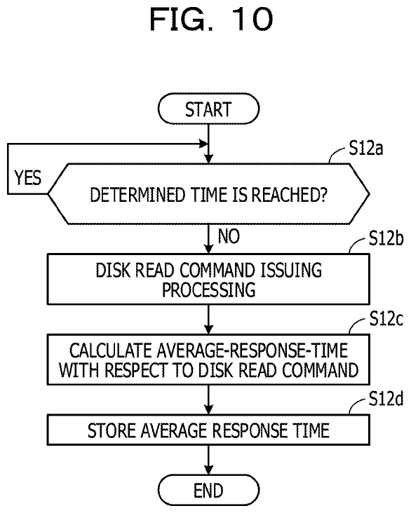

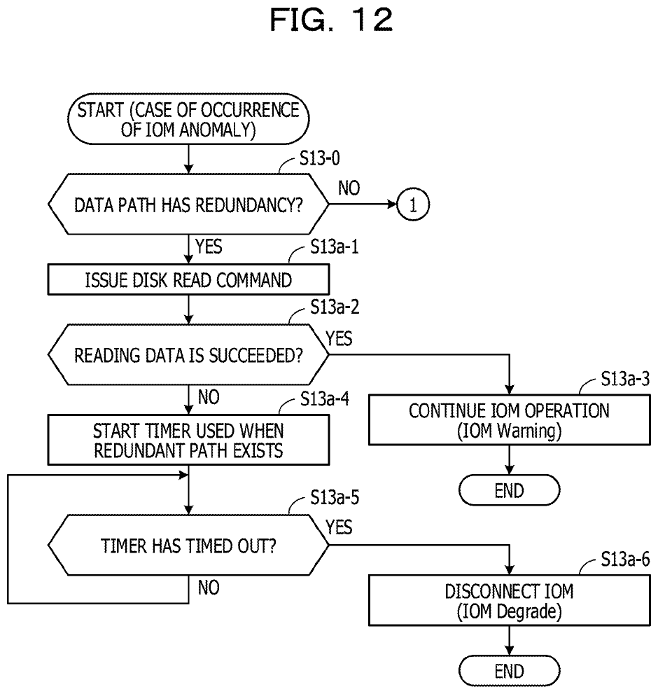

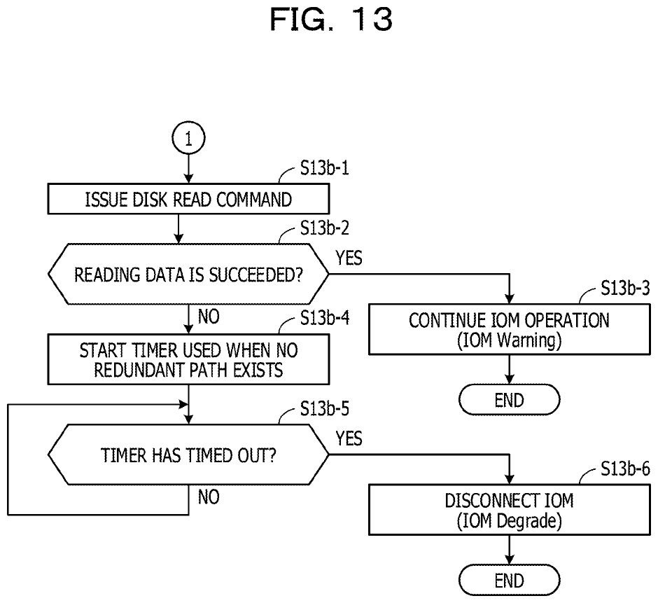

FIG. 9 is a flowchart illustrating overall operation of the controller.

[Step S11] The controller 12 performs IOM anomaly monitoring processing via the I2C interface. When no anomaly is detected at a particular IOM, the process proceeds to step S12. By contrast, when anomaly is detected at a particular IOM, the process proceeds to step S13.

[Step S12] The controller 12 issues a DISK Read command to a recording device coupled to the IOM and obtains an average response time with respect to the DISK Read command (as will be described later with reference to FIG. 10). The process then returns to step S11.

[Step S13] The controller 12 performs IOM operation continuation determination processing with respect to the IOM at which anomaly is detected (as will be described later with reference to FIGS. 12 and 13). The process then returns to step S11.

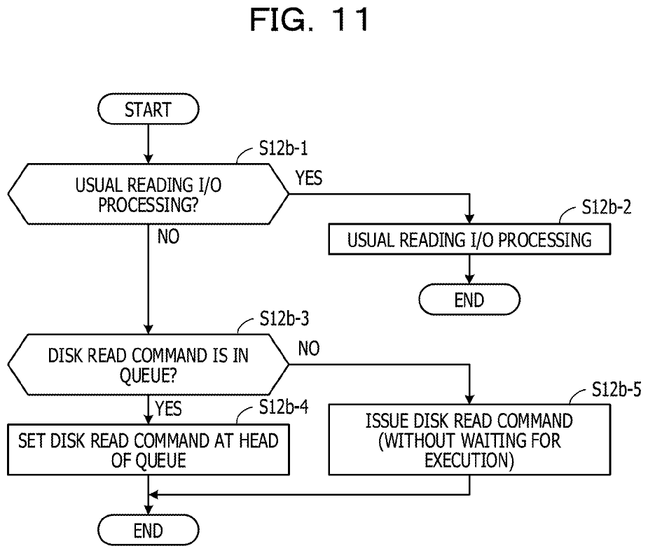

FIG. 10 is a flowchart illustrating average-response-time acquisition operation.

[Step S12a] The controller 12 determines whether a determined time used for starting IOM anomaly monitoring processing has been reached. When the determined time has been reached, the process proceeds to step S12b. Conversely, when the determined time has not been reached, the processing in step S12a is repeated.

[Step S12b] The controller 12 issues a DISK Read command (as will be described later with reference to FIG. 11).

[Step S12c] The controller 12 calculates an average response time with respect to the DISK Read command in accordance with the equation described above.

[Step S12d] The controller 12 registers the calculated average response time in the average-response-time management table 13a.

FIG. 11 is a flowchart illustrating operation of DISK Read command issuing processing.

[Step S12b-1] When reading I/O processing is to be performed, the controller 12 determines whether the reading I/O processing is usual reading I/O processing for a recording device or reading I/O processing in the case of performing the IOM operation continuation determination processing.

When it is determined that the usual reading I/O processing is to be performed, the process proceeds to step S12b-2. By contrast, when it is determined that the reading I/O processing in the case of performing the TOM operation continuation determination processing is to be performed, the process proceeds to step S12b-3.

[Step S12b-2] The controller 12 performs the usual reading I/O processing with regard to a recording device.

[Step S12b-3] The controller 12 determines whether the DISK Read command is in a ready queue. When the DISK Read command is in the ready queue, the process proceeds to step S12b-4. When the DISK Read command is not in the ready queue, the process proceeds to step S12b-5.

[Step S12b-4] The controller 12 sets the DISK Read command at the head of the ready queue and then issues the DISK Read command.

[Step S12b-5] The controller 12 does not put the DISK Read command in the queue (without waiting for execution) and issues the DISK Read command.

FIGS. 12 and 13 are flowcharts illustrating operation of the IOM operation continuation determination processing. The flowcharts illustrate the operation of the IOM operation continuation determination processing after anomaly is detected at the IOM.

[Step S13-0] The controller 12 refers to the redundant-path information management table 13b managed in the memory 13 and accordingly determines whether there is a redundant data path connecting the CM and the recording device. When the redundant data path exists, the process proceeds to step S13a-1. Conversely, when no redundant data path exists, the process proceeds to step S13b-1.

[Step S13a-1] The controller 12 issues a DISK Read command.

[Step S13a-2] The controller 12 determines whether data reading from a recording device coupled to the suspect IOM is properly performed by executing the DISK Read command.

When data reading is properly performed via the IOM at which anomaly is detected, the process proceeds to step S13a-3. In contrast, when data reading is not able to be performed, the process proceeds to step S13a-4.

[Step S13a-3] The controller 12 continues to operate the suspect IOM (disconnection of the IOM from communication with CM is not performed). The controller 12 also sets a warning status (IOM Warning) for the suspect IOM to indicate the suspect IOM as a target for precaution maintenance.

[Step S13a-4] The controller 12 starts the timer 12d1 that is used when a redundant path exists.

[Step S13a-5] The controller 12 determines whether the timer 12d1 has timed out. When the timer 12d1 has timed out, the process proceeds to step S13a-6. Conversely, when the timer 12d1 has not timed out, the timer 12d1 continues time counting.

[Step S13a-6] The controller 12 disconnects the suspect IOM from communication with the CM after the threshold time t1 that is set in the timer 12d1 elapses.

[Step S13b-1] The controller 12 issues a DISK Read command.

[Step S13b-2] The controller 12 determines whether data reading from a recording device coupled to the suspect IOM is properly performed by executing the DISK Read command.

When data reading is properly performed via the IOM at which anomaly is detected, the process proceeds to step S13b-3. In contrast, when data reading is not able to be performed, the process proceeds to step S13b-4.

[Step S13b-3] The controller 12 continues to operate the suspect TOM (disconnection of the IOM from communication with CM is not performed). The controller 12 also sets a warning status (IOM Warning) for the suspect IOM to indicate the suspect IOM as a target for precaution maintenance.

[Step S13b-4] The controller 12 starts the timer 12d2 that is used when no redundant path exists.

[Step S13b-5] The controller 12 determines whether the timer 12d2 has timed out. When the timer 12d2 has timed out, the process proceeds to step S13b-6. When the timer 12d2 has not timed out, the timer 12d2 continues time counting.

[Step S13b-6] The controller 12 disconnects the suspect IOM from communication with the CM after the threshold time t2 that is set in the timer 12d2 elapses.

As described above, the technology according to the present disclosure performs access diagnostic testing with respect to a recording device associated with an IOM at which anomaly is detected, and when access is failed, changes a threshold time whose length varies depending on whether there is a redundant path connecting to the recording device and disconnects the TOM from communication after the changed threshold time elapses.

Specifically, when a redundant path exists, the location of anomaly is disconnected after the threshold time t1 that is relatively short elapses; in contrast, when no redundant path exists, the location of anomaly is not immediately disconnected, that is, the location of anomaly is disconnected after operation at the location of anomaly is continued for a given time and the threshold time t2 that is relatively long elapses. Such a control enables the time until which operation at the location of anomaly is continued to be changed depending on the redundant configuration of a device, and thus, the continuation of operation at the location of anomaly is determined in accordance with the configuration of the device.

In addition, it is possible to maximize the availability of an IOM as much as possible and it is also possible to render the effect on host access less severe. Furthermore, operation continuation determination processing is performed in consideration of the redundancy of data path, and thus, the loss of data path less likely occurs.

Moreover, in the controller 12, the threshold time t2 counted by the timer 12d2 is, for example, a time equal to or less than a determined time and the threshold time t1 counted by the timer 12d1 is determined to be shorter than the threshold time t2.

With this configuration, regardless of whether a redundant path exists, the abnormal IOM is disconnected within a determined time, and as a result, it is possible to improve operability and reliability.

The above-described processing functions of the storage apparatus 1 and the CM 10 according to the present disclosure may be achieved by a computer. In this case, a program that describes details of processing to be performed by functions of the storage apparatus 1 and the CM 10 is provided. The computer executes the program, so that the processing functions are implemented on the computer.

The program in which the content of processing is written may be recorded on a computer-readable recording medium. Examples of the computer-readable recording medium include a magnetic recording device, an optical disk, a magneto-optical recording medium, and a semiconductor memory. Examples of the magnetic recording device include a hard-disk device (HDD), a floppy disk (FD), and a magnetic tape. Examples of the optical disk include CD-ROM/RW. One example of the magneto-optical recording medium is a magneto optical (MO) disk.

When the program is to be distributed, for example, portable recording media, such as CD-ROMs, on which the program is recorded are sold. The computer program may be stored in a recording device of a server computer and transferred from the server computer to another computer through a network.

The computer that executes the program stores, for example, the program, recorded on the portable recording medium, or the program, transferred from the server computer, in a recording device of the computer. The computer then reads the program from the recording device thereof and executes processing according to the program. The computer may directly read the program from the portable recording medium and may execute processing according to the program.

Every time the program is transferred from a server computer connected through a network, the computer may responsively execute processing according to the received program. Alternatively, any one or any combination of the processing functions described above may be implemented by an electronic circuit, such as a DSP, an ASIC, or a PLD.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage apparatus, comprising:
a memory;
a relay device configured to relay access to the memory; and
a processor coupled to the relay device and configured to:
when anomaly is detected by monitoring for the relay device, perform diagnostic testing with respect to the access to the memory via the relay device, and
when it is detected that the access is failed, change a threshold time in accordance with whether a redundant path connecting to the memory exists, the threshold time indicating a period from a time when it is detected that the access is failed to a time when disconnection of the relay device from communication with the processor is performed.

2. The storage apparatus according to claim 1, wherein the processor is configured to:
when the redundant path connecting to the memory exists, select a first threshold time, and
when the redundant path does not exist, select a second threshold time longer than the first threshold time.

3. The storage apparatus according to claim 1, wherein the processor is configured to:
when the diagnostic testing with respect to the access is performed, issue a read command for reading data from the memory, and
determine whether the access is succeeded in accordance with whether the data is able to be properly read from the memory.

4. The storage apparatus according to claim 1,
wherein the processor is configured to monitor for the relay device by using a second interface that is coupled to the relay device and whose speed is faster than that of a first interface that is used when input/output communication with the memory is performed.

5. A non-transitory computer-readable recording medium storing a program that causes a computer to execute a process, the process comprising:
when anomaly is detected by monitoring for a relay device, performing diagnostic testing with respect to access to a memory via the relay device; and
when it is detected that the access is failed, changing a threshold time in accordance with whether a redundant path connecting to the memory exists, the threshold time indicating a period from a time when it is detected that the access is failed to a time when disconnection of the relay device from communication with a processor is performed.

6. The recording medium according to claim 5, wherein the changing includes:
when the redundant path connecting to the memory exists, selecting a first threshold time, and
when the redundant path does not exist, selecting a second threshold time longer than the first threshold time.

7. The recording medium according to claim 5, wherein the performing the diagnostic testing includes:
when the diagnostic testing with respect to the access is performed, issuing a read command for reading data from the memory, and determining whether the access is succeeded in accordance with whether the data is able to be properly read from the memory.

8. The recording medium according to claim 5, further comprising
monitoring for the relay device by using a second interface that is coupled to the relay device and whose speed is faster than that of a first interface that is used when input/output communication with the memory is performed.
